(19) United States
(12) Patent Application Publication
(10) Pub. No.: US 2024/0214279 A1
(43) Pub. Date: Jun. 27, 2024

(54) MULTI-NODE SERVICE RESILIENCY

(71) Applicant: Intel Corporation, Santa Clara, CA (US)

(72) Inventors: Matthew J. ADILETTA, Bolton, MA (US); Zane BALL, Portland, OR (US); Susanne M. BALLE, Hudson, NH (US); Patrick CONNOR, Beaverton, OR (US)

(21) Appl. No.: 18/433,291

(22) Filed: Feb. 5, 2024

(51) Int. Cl. H04L 41/5019; H04L 41/16; H04L 43/0823

(52) U.S. Cl. CPC H04L 41/5019; H04L 41/16; H04L 43/0823

(57) ABSTRACT

Examples described herein relate to determining whether to process or not process data based on a reliability metric. For example, based on receiving a response to a request to a first microservice, with the reliability metric, from one or more servers, a decision can be made of whether to process, by a second microservice, a result associated with the response based on the reliability metric. In some examples, the reliability metric comprises an indicator of memory health and computational accuracy.

### BACKGROUND

A microservice can be characterized by polyglot programming (e.g., code written in multiple languages), a lightweight container or virtual machine deployment, and decentralized microservice execution. A service mesh facilitates communications between microservices using application programming interfaces (APIs). Kubernetes Container Network Interface (CNI) plugins can be used without a service mesh to provide microservice-to-microservice communications. Microservice communications can utilize Hypertext Transfer Protocol (HTTP), HTTP/2, Kafka, MongoDB wire protocol, RESTful services, remote procedure call (RPC), and/or Cloud Native Computing Foundation's gRPC (gRPC Remote Procedure Call) which uses protocol buffers (protobuf) as the binary data interchange format for inter-service communication.

Some microservices are sensitive to accuracy of results returned by called microservices. Safety-critical applications generally request results from two or more servers and compare the results by majority/minority voting redundancy (MMR) or an N-modular redundancy (NMR) scheme. 2MR is a case where an operation is performed redundantly (two times). If the results agree or match, then the result is trusted and used. However, if the results do not agree or match, then more results are requested.

### BRIEF DESCRIPTION OF THE DRAWINGS

FIG. 1 shows an example system.

FIG. 2 shows an example of request and response semantics.

FIG. 3 shows an example system.

FIG. 4 shows an example of request and response semantics.

FIGS. 5A-5C depict example processes.

FIG. 6 depicts an example system.

FIG. 7 depicts an example system.

### DETAILED DESCRIPTION

Remote servers that execute microservices utilize memory devices to store data. Failures in memory technology (e.g., Dynamic Random Access Memory (DRAM)) can lead to corruption of data and computational errors, which can have a direct impact on the reliability, availability, and serviceability (RAS) of servers and can potentially disrupt data center continuity. Some errors in data are correctable errors (CEs), such as single bit errors, single row errors, and multi-array errors. Some single bit errors can be corrected using Error Correction Code (ECC), System ECC, Single Data Device Correction (SDDC), Post-Package Repair (PPR), and Intel® Memory Resilience Technology. However, some errors in stored data are not correctable. Various examples herein can consider telemetry indicative of memory errors (e.g., correctable or uncorrectable memory errors) at a remote server that executes a microservice to generate data. Based on the telemetry, a determination can be whether to utilize the generated data or discard the generated data, or other corrective actions.

In some examples, a first server node can execute a client microservice and the client microservice can submit a microservice request to a remote server node to perform data processing with a call to an Application Programming Interface (API) to provide feedback which indicates a health or resiliency indicator of memory of the remote server node. The remote server node can provide, with or separate from the service result (e.g., data), feedback which indicates the health of memory of the remote node by Memory Resiliency Technology (MRT). The remote node can utilize processor-executed software, firmware, and/or circuitry to determine a health indicator of memory of the remote node. The health of the memory of the remote node can indicate a possibility of error in the service result. The health of the memory can indicate memory error, faulty double data rate (DDR) memory device, number of corrected errors by ECC operations, number of uncorrected errors by ECC operations, number of computation errors (e.g., arithmetic or non-arithmetic), number of row faults, number of column faults, or number of bank faults. Based on the health indicator from the remote node, the client application can process the data from the remote server node or discard the data from the remote server node and re-submit the microservice request to another server node.

In some examples, based on a priority of microservice request or the health indicator level of the memory of the remote node being below a configured level, a server that executes the client microservice can issue the request to two or more remote nodes or network interface devices. A number of remote nodes or network interface devices that the server, that executes the client microservice, transmits the request to can be based on the priority of the microservice request. Two or more remote nodes can perform the microservice request and report back results and, if requested, a memory health or resiliency indicator. Based on consistency of received results (e.g., matching results) and/or the health indicator from the remote node, the client application can process the data from the remote server node or discard the data from the remote server node and submit the microservice request to another two or more server nodes.

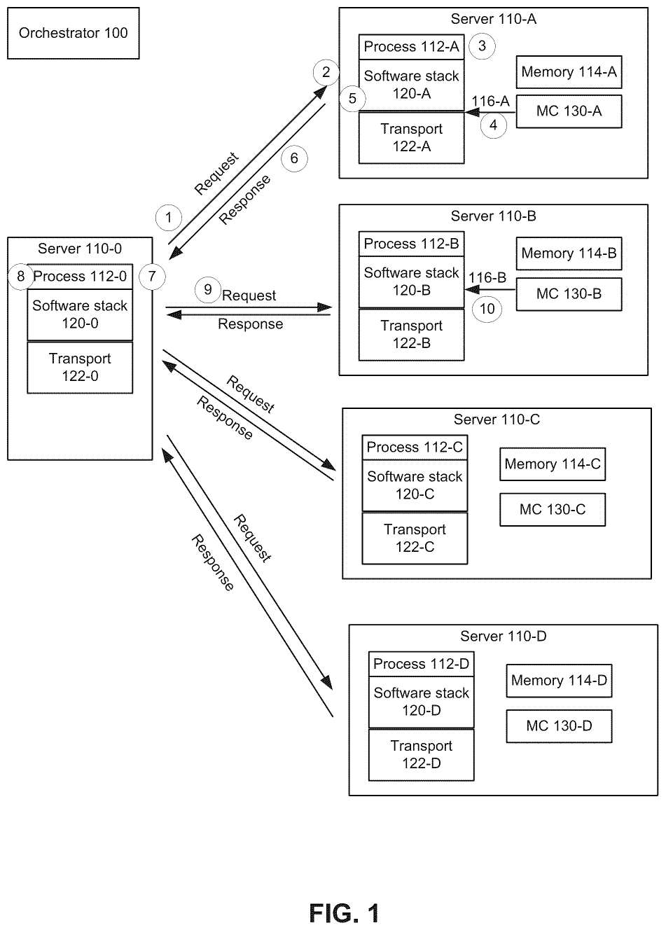

FIG. 1 depicts an example system. Microservices software stack 120-0 can permit one or more servers (e.g., 110-0, 110-A, 110-B, 110-C, and/or 110-D) to receive a workload or microservice call from process 112-0 based on one or more prior levels of memory errors relative to a configured acceptable memory error level and exclude servers from receipt of the workload from process 112-0 based on one or more prior memory error levels relative to the configured acceptable memory error level. Examples of orchestrator 100 can be based on Amazon® Lambda, Kubernetes, Microsoft® Azure function, Google® CloudRun, Knative, Microsoft® Azure, or others.

In some examples, prior to selection of a remote server to execute a microservice call from process 112-0, software stack 120-0 and/or orchestrator 100 can perform a check of memory error or resiliency levels from servers 110-0, 110-A, 110-B, 110-C, and/or 110-D and exclude one or more of servers 110-0, 110-A, 110-B, 110-C, and/or 110-D from receipt of a workload or microservice call from process 112-0 based on memory error levels of servers 110-0, 110-A, 110-B, 110-C, and/or 110-D. For example, if server 110-B and 110-C provide memory error or resiliency levels that exceed a threshold level, software stack 120-0 and/orchestrator 100 can exclude server 110-B and 110-C from receipt of workloads or microservice call from process 112-0.

In some examples, servers 110-0, 110-A, 110-B, 110-C, and/or 110-D can issue health or resiliency indicators 116 to software stack 120-0 and/or orchestrator 100 in response to a request from software stack 120-0 and/or orchestrator 100. In some examples, servers 110-0, 110-A, 110-B, 110-C, and/or 110-D can issue or push health indicators 116 to software stack 120-0 and/or orchestrator 100, proactively. Other numbers of servers can be available for use.

In some examples, if a memory error level of server 110-0 is at or above an administrator configured level, software stack 120-0 and/or orchestrator 100 can cause migration of process 112-0 to another server that reported a memory error level that is below the configured level and cause server 110-0 to not be considered an acceptable recipient of microservice calls until a memory error level of server 110-0 is less than the configured level.

Software stack 120-0 and/or orchestrator 100 can select a remote server to perform a workload based on use of a neural network (NN) on one or more prior levels of memory errors from remote servers to reduce a likelihood of occurrence of transient memory error or transient computation or arithmetic error. The NN can implement a Bayesian optimization to define and predict the best nodes to receive requests based on previous errors, status patterns, or missing responses, or to correlate the responses from the multiple replies and decide which node to select for data computation accuracy. In some examples, software stack 120-0 and/or orchestrator 100 can cause consecutive requests to perform workloads to be sent to different target servers.

Software stack 120-0 and/or orchestrator 100 can determine on how many instances of target microservices to run based on the mission critical value, remote system health, historical data for previous transitions (e.g., complexity of requests), etc.

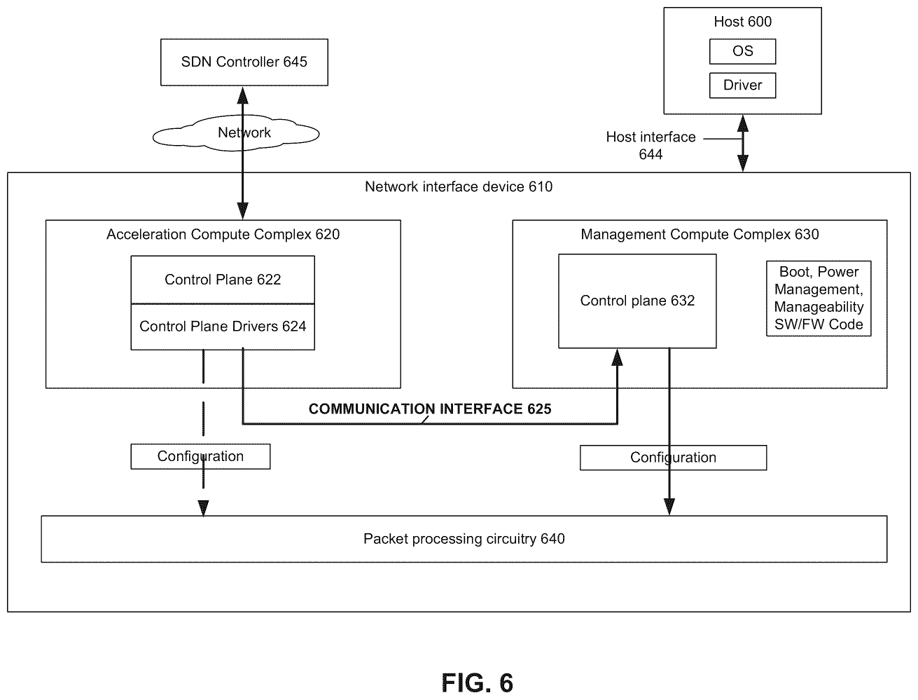

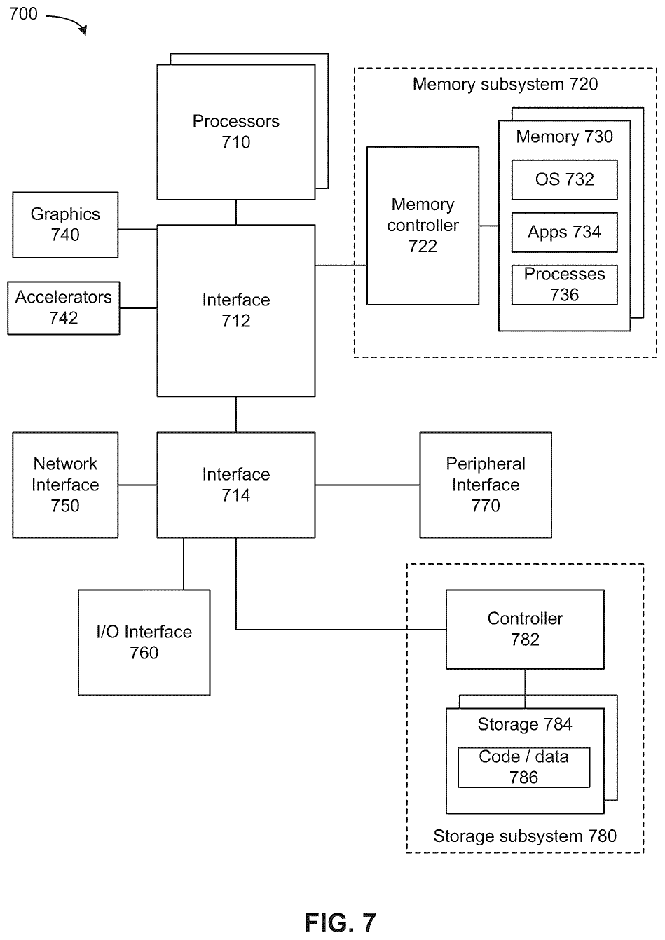

Various examples of servers 110-0, 110-A, 110-B, 110-C, and/or 110-D are described with respect to FIGS. 6 and 7. In some examples, servers 110-0, 110-A, 110-B, 110-C, and/or 110-D can include a network interface device, memory pool, and/or accelerator. In some examples, server 110-0 can execute a client process 112-0 and client process 112-0 can submit a service request to a non-excluded target remote server (e.g., one or more of servers 110-A, 110-B, 110-C, and/or 110-D) to perform a target process (e.g., process 112-A, 112-B, 112-C, or 112-D) with a call to an Application Programming Interface (API) for the target remote server to provide feedback which indicates health indicator 116 of memory 114 of the target remote server.

Software stack 120-0 can include a reliability layer that can utilize an Artificial Intelligence (AI)/Machine Learning (ML) engine implementing a Bayesian optimization or neural network to predict the nodes to send one or more requests to based on previous errors and status patterns.

Transport 122-0 can provide an interface to a service mesh. Service meshes can act as ingress gateway or sidecar proxy and can encrypt or decrypt data, compress or decompress data, modify headers of packets, and convert protocols for incoming and outcoming connections and requests. A service mesh can utilize a cloud native network proxy distributed runtime that performs data copy and movement operations.

In some examples, one or more of process 112-0, 112-A, 112-B, 112-C, and/or 112-D can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in virtual execution environments. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some applications can perform video processing or media transcoding (e.g., changing the encoding of audio, image or video files).

Processor-executed software, firmware, and/or circuitry of the target remote node can determine health indicator 116 of memory 114. For example, a management controller (MC) (e.g., Baseband Management Controller (BMC), Intel® Management or Manageability Engine (ME), or other devices) of the target remote server node can collect and provide detected memory error data.

A management controller (MC) can perform management and monitoring capabilities for system administrators to monitor operation at least of servers 110-0 and 110-A to 110-D (and devices connected thereto) using channels, including channels that can communicate data (e.g., in-band channels) and out-of-band channels. Out-of-band channels can include packet flows or transmission media that communicate metadata and telemetry and may not communicate data.

An MC can be implemented in accordance with OpenBMC platform telemetry based on Distributed Management Task Force (DMTF) Redfish® (e.g., Redfish Scalable Platforms Management API Specification version 1.0 (2015) as well as earlier versions, later versions, and variations thereof) for exposing platform telemetry over a network. For example, software stack 120-0 and 120-A to 120-D, a memory controller of memory 114 or a Compute Express Link (CXL) consistent interface to memory 114 can collect and provide detected memory error indicator 116.

Memory 114 can include one or more of: one or more registers, one or more cache devices (e.g., level 1 cache (L1), level 2 cache (L2), level 3 cache (L3), last level cache (LLC)), volatile memory device, non-volatile memory device, or persistent memory device. For example, memory 114 can include static random access memory (SRAM) memory technology or memory technology consistent with high bandwidth memory (HBM), or double data rate (DDR), among others. Memory 114 can store data to be transmitted, data received in packets, data to be processed, generated data, and other metadata.

The requested target remote server can provide, with or separate from the service result, feedback which indicates health or resiliency indicator 116 of memory 114 of the requested target remote node. Health indicator 116 of memory 114 of the target remote node can indicate a possibility of error along with the results. Health indicator 116 of memory 114 can indicate a memory error, faulty DDR memory device, number of corrected errors by ECC operations, number of uncorrected errors by ECC operations, number of computation errors (e.g., arithmetic or non-arithmetic), number of row faults, number of column faults, or number of bank faults. In some examples, indicator 116 can be a value of memory health, where a higher value of memory health indicates a lower number of memory errors and a lower value of memory health indicates a higher number of memory errors. A memory health indicator level can be based on even or uneven weighting of memory error levels identified in indicator 116. Other schemes can be used to indicate memory health.

Based on a level of health indicator 116 in a response, software stack 120-0 or processor-executed software, process 112-0, firmware, and/or circuitry of server 110-0 can determine whether process 112-0 is to process the data from the target remote node. For example, if a level of health indicator 116 is at or above a configured level by process 112-0 or set by an administrator, process 112-0 is to process the data from the target remote node. For example, if a level of health indicator 116 is below a configured level by process 112-0 or set by an administrator, process 112 is not to process the data from the target remote node because data received from target server may be erroneous and/or subject to fault computation. Based on a determination to not permit process 112 to process the data from the target remote node, server 110-0 can discard received data from the target remote node and/or re-submit the microservice request to one or more other server nodes (e.g., server 110-A and/or 110-B). Process 112-0, software stack 120-0, and/or orchestrator 100 can inform an administrator if memory errors exceed a level to take corrective action.

An example of operations is as follows. At (1), process 112-0 executing on server 110-0 can send a request message to process 112-A executing on remote server 110-A. At (2), process 112-A executing on server 110-A receives the message from server 110-0. At (3), process 112-A executing on server 110-A processes the request message and generates data in accordance with the request message. At (4), server 110-A collect health indicator 116-A telemetry from MC 130-A using collectd, Linux hwmon, or other tools. At (5), software stack 120-A and/or process 112-A can assemble Reply API message including generated data and memory health indicator 116-A. At (6), server 110-A sends reply message to server 110-0 with data generated by process 112-A and health indicator 116-A.

At (7), software stack 120-0 or process 112-0 executing on server 110-0 receives the reply message with processed data along with health indicator 116-A. At (8), software stack 120-0 or process 112-0 executing on server 110-0 unpacks or unmarshalls the health indicator 116-A and processed data result. At (9), if memory health indicator 116 is not an acceptable level, then software stack 120-0 or process 112-0 on server 110-0 sends the same request to remote server 110-B while storing data results and memory health indicator 116-A for server 110-A. Health indicator 116-A can be used for logging or error analysis. Fault-tolerant operations continue until a predefined policy is reached (e.g., peak number of retries to different servers).

At (10), if the memory health indicator 116-B from server 110-B is an acceptable level, process 112-0 executing on server 110-0 can access the data from server 110-B in a next phase.

Note while the example of operations utilizes a MC to gather memory health indicators, other implementations can use a reliability layer or other process to gather memory health indicators.

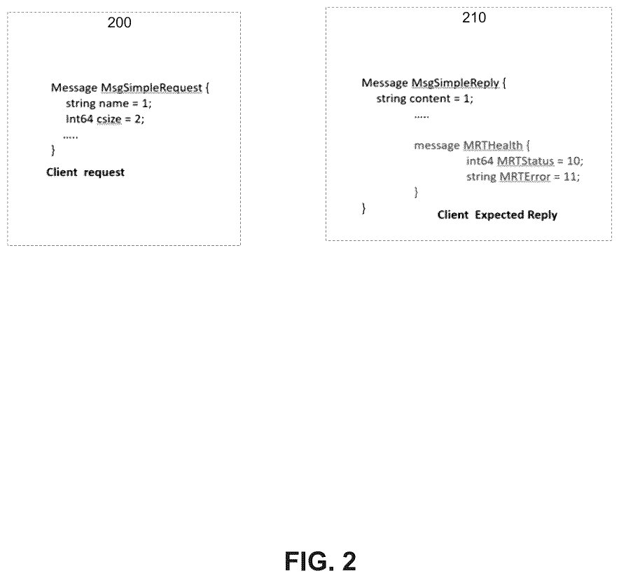

FIG. 2 depicts an example API with a feedback field for a health indicator. The API can be consistent with go, gRPC, REST APIs, RUST APIs, wrapped languages (e.g., Python, C++, Java, etc.), and others. For example, in 200, a client can request a remote server to provide processed or generated data in a reply. In 210, the remote server can reply that memory health indicator is generated and available in a location in a stream specified by MRTStatus=10 (e.g., position 10 of the stream). For example, a server can specify a memory health indicator level value in a location in a stream specified by MRTError=11 (e.g., position 11 of the stream).

In some examples, use of semantics of reply 210, or a reply with a health indicator, can either be added manually by a developer into process 112-0 or software stack 120-0 in a stub or proto file, added automatically by a toolchain or compiler (e.g., a gRPC protocol buffer compiler, protoc) which can generate a stub (e.g., *. pb.go) when compiling code, or by a gRPC communication stack that directly injects reply 210 into a marshalled bitstream for the gRPC request to the remote server.

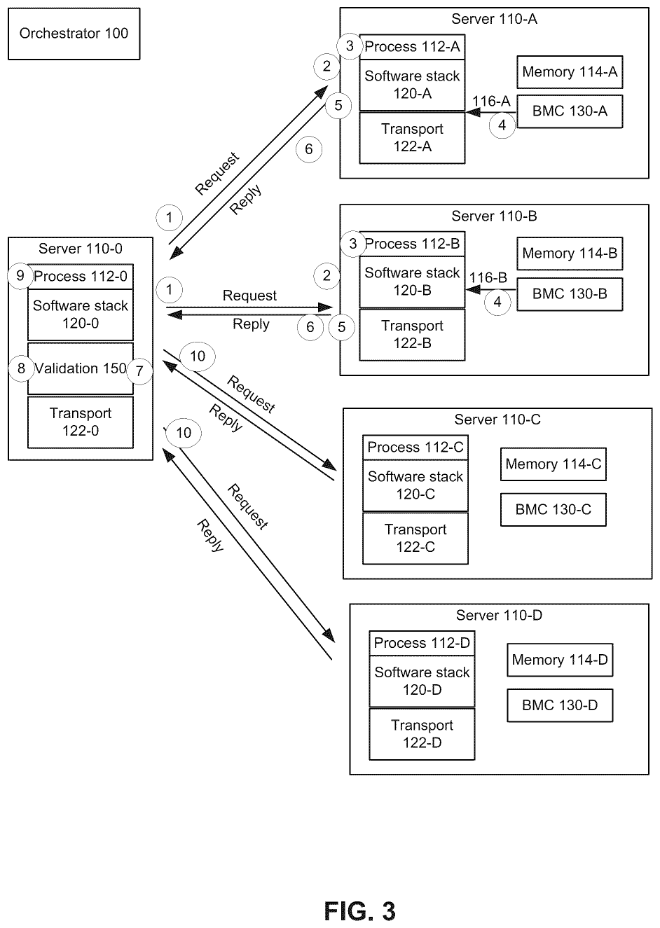

FIG. 3 depicts an example system. In some examples, client process 112-0 can cause issuance of a workload request to a number of remote nodes or network interface devices, based on a priority of the workload request. Client process 112-0 can call an API with a field indicating mission criticality or priority level and/or a feedback field for health indicator, described earlier. Orchestrator 100 can set up communications among servers via a network or other communication technologies. Based on a priority level, software stack 120-0 can select a number of target servers (e.g., servers 110-0, 110-A, 110-B, 110-C, and/or 110-D) to perform the workload request or microservice call. As described earlier, the target servers that are candidates to perform the workload request or microservice call can be based on health indicator data. For example, based on a priority level being above a configured level, orchestrator 100 can select two or more target servers to perform the workload request and report back results of data processing or generation to process 112-0. The configured level can be set by client process 112-0, a data center administrator, and/or orchestrator 100. In some examples, a number of target servers can be based on the priority level so that a higher priority level can utilize more numbers of target servers.

In some examples, a load balancer in software stack 120-0 can perform a Kubernetes resiliency layer and determine a number of nodes to send a request to. In some examples, a load balancer in software stack 120-0 can process received messages (e.g., gRPC) to determine memory errors and transient errors.

In some examples, software stack 120-0 can perform a reliability layer that can utilize an Artificial Intelligence (AI)/Machine Learning (ML) engine implementing a Bayesian optimization or neural network to predict the nodes to send one or more requests to based on previous errors and status patterns, or to correlate the responses from the multiple replies and decide which one or more nodes to select to receive requests to provide sufficient accuracy. Moreover, software stack 120-0 can utilize the AI/ML engine to predict a number of requests to be sent (and corresponding number of target servers) to receive a trusted result based on previous errors, status patterns, missing responses, etc.

To check for arithmetic computation or transient errors from the workload performing servers, validation 150 of server 110-0 can determine which results from multiple remote servers to permit processing by process 112-0 based on whether results from multiple servers match or are consistent and/or based on memory error telemetry. In some examples, validation 150 can be implemented as processor-executed software, firmware, and/or circuitry. In some examples, validation 150 can be performed by a client process 112-0 or Kubernetes-consistent resiliency layer in software stack 120-0 that checks memory error levels, as described earlier, or other software.

In some examples, validation 150 can select data with a least level of memory errors indicated by indicator 116, from among data from multiple target servers, provided the level of memory errors for the received data is less than a configured threshold level and the results are consistent. In some examples, validation 150 can select data from a target server received before data from another target server, provided the level of memory errors for the received data is less than a configured threshold level and the multiple target servers generated consistent results previously. The threshold level and the number of received data results can be set by client process 112-0, a data center administrator, and/or orchestrator 100.

An example of operations is as follows. At (1), based on the priority level parameter, process 112-0 can send a same request to multiple target servers, e.g., servers 110-A and server 110-B. At (2), processes 112-A and 112-B receive the request messages. At (3), processes 112-A and 112-B process the request messages and generate data in accordance with the request messages. At (4), server 110-A collect health indicator 116-A telemetry from MC 130-A using collectd, Linux hwmon, or other tools. Similarly, server 110-B collect health indicator 116-B telemetry from MC 130-B using collectd, Linux hwmon, or other tools. At (5), software stack 120-A and/or process 112-A can assemble Reply API message including generated data and memory health indicator 116-A. Similarly, software stack 120-B and/or process 112-B can assemble Reply API message including generated data and memory health indicator 116-B. At (6), servers 110-A and 110-B send reply messages to server 110-0 with data generated by respective processes 112-A and 112-B and respective health indicators 116-A and 116-B.

At (7), validation 150 executing on server 110-0 receives the reply messages with processed data along with health indicators 116-A and 116-B. At (8), validation 150 executing on server 110-0 unpacks or unmarshalls the health indicators 116-A and 116-B and data results. At (9), based on data results from servers 110-A and 110-B matching, validation 150 can permit utilization of the data by process 112-0. In some examples, validation 150 can permit utilization of the data by process 112-0 based on health indicators 116-A and 116-B meeting or exceeding a configured level. In some examples, validation 150 can permit utilization of the data by process 112-0 for matching data regardless of level of health indicators 116-A and 116-B.

At (10), based on the returned data not matching and/or a level of health indicators 116-A and/or 116-B being below the configured level, then process 112-0 on server 110-0 sends the same request, from (1), to target server 110-C and/or 110-D, and processes replies from target server 110-C and/or 110-D using operations (8) and (9). Operations (8)-(10) can continue on different target servers based on a predefined policy (e.g., peak number of retries to different servers).

For example, in the case of a database update, the database access API can transmit multiple requests for data and when the database API validates the received data is consistent, perform the requested data update in a database.

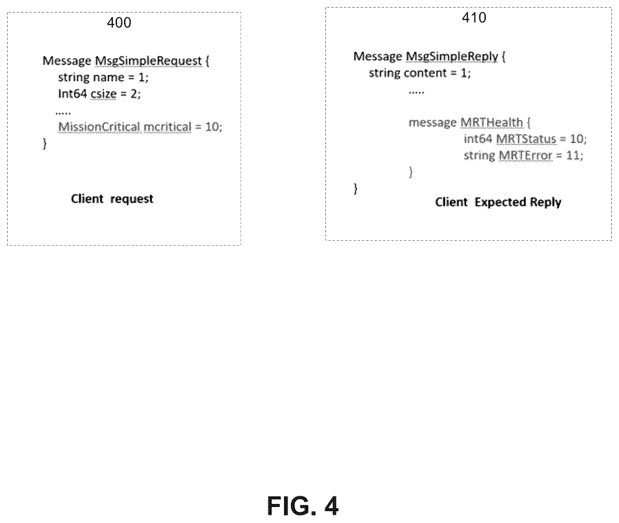

FIG. 4 depicts an example API with a priority level indicator and a feedback field for a health indicator. The API can be consistent with go, gRPC, REST APIs, RUST APIs, wrapped languages (e.g., Python, C++, Java, etc.), and others. In API MsgSimpleRequest 400, a client can indicate a priority of a workload request. For example, parameter MissionCritical can indicate a predefined or user-defined job mission critical parameter. The parameter can define an importance level of the request. If the importance level is at or higher than a level, the same request can be sent to multiple target servers. In some examples, a number of target servers to which to send the same request can be based on the importance level.

In API MsgSimpleReply 410, MRTHealth message is a feedback API describing the memory health of the server application node, as described earlier. In 410, the target server can reply that a memory health indicator is generated and available in a location in a stream specified by MRTStatus=10 (e.g., position 10 of the stream). For example, a server can specify a memory health indicator level value in a stream in memory specified by MRTError=11 (e.g., position 11 of the stream).

In some examples, use of semantics of request 400 and reply 410 can either be added manually by a developer into process 112-0 or software stack 120-0 in a stub or proto file, added automatically by a toolchain or compiler (e.g., a gRPC protocol buffer compiler, protoc) which can generate a stub (e.g., *. pb.go) when compiling code, or by a gRPC communication stack that directly injects reply 410 into a marshalled bitstream for the gRPC request to the remote server.

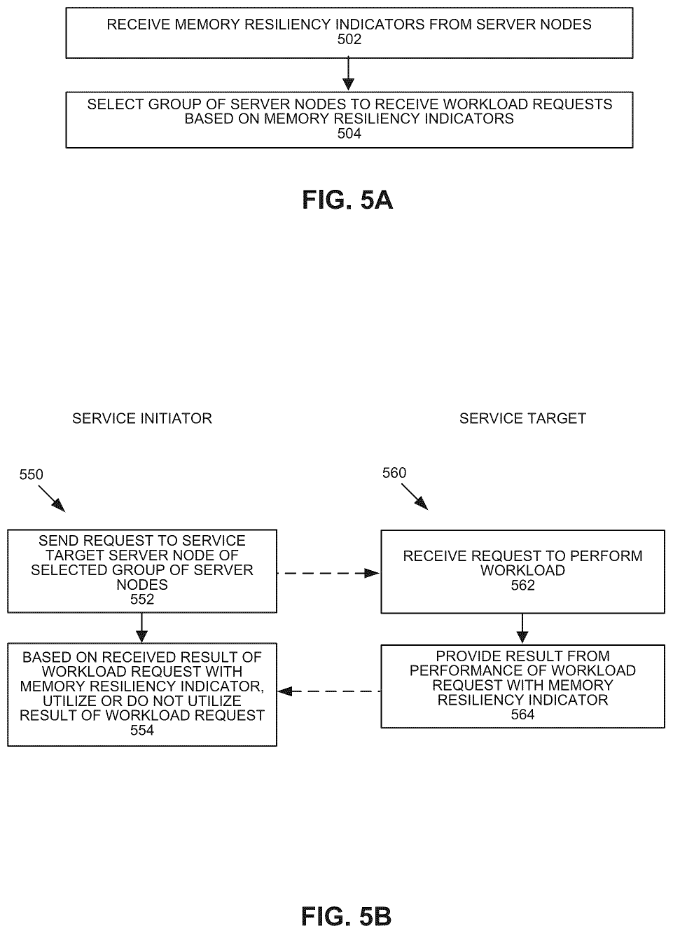

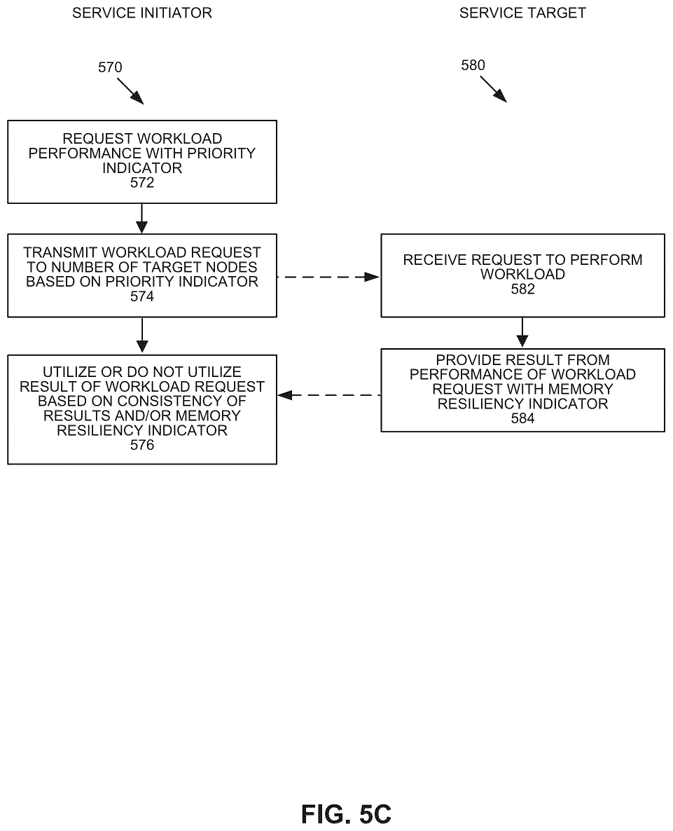

FIG. 5A depicts an example process. The process can be performed by an orchestrator, process, operating system (OS), hypervisor, or other processor-executed software or circuitry. At 502, reliability, memory resiliency, or health indicators from multiple server nodes can be received. The reliability, memory resiliency, or health indicators can indicate a number of correctable or uncorrectable errors and whether memory in the server node is faulty. At 504, based on the memory reliability, memory resiliency, or health indicators from multiple server nodes, a set of server nodes can be selected to perform workload requests. For example, if a level indicated by a memory reliability, memory resiliency, or health indicators is less than a threshold level, the associated server node can be considered to have faulty memory devices and provide unreliable computations and such associated server node could be excluded from receipt of workload requests. Note that the process of FIG. 5A can be repeatedly performed to disqualify or allow server nodes to receive workload requests based on memory resiliency or health indicators.

FIG. 5B depicts an example process. The process can be performed by an operating system (OS), process, hypervisor, or other processor-executed software or circuitry in one or more server nodes. Process 550 can be performed by a server node. At 552, a service initiator can send a request to perform a workload to a target server node. The target server node can be among the group of allowed server nodes selected using the process of FIG. 5A. At 554, based on receipt of a result of a workload with a memory resiliency or health indicator, the result can be utilized or not utilized. For example, if a level indicated by a memory resiliency or health indicator is more than a threshold level, the data can be selected for processing by a service initiator process. For example, if the level indicated by the memory resiliency or health indicator is less than or equal to the threshold level, the data may not be selected for processing by the service initiator process.

Process 560 can be performed by a target server node. At 562, a target server node can receive a request to perform a workload. At 564, the target server node can provide a result of a workload with a memory resiliency or health indicator. For example, the memory resiliency or health indicator can be generated by a management controller or other process and indicate a level of errors in memory of the target server node.

FIG. 5C depicts an example process. The process can be performed by an operating system (OS), process, hypervisor, or other processor-executed software or circuitry in one or more server nodes. Process 570 can be performed by a server node. At 572, a service initiator can send a request to perform a workload with a priority indicator to at least one target server node. At 574, a number of target server nodes can be selected based on a priority level in the priority indicator. The target server nodes can be among the group of allowed server nodes selected using the process of FIG. 5A. The server node can transmit the request to the selected number of target server nodes.

At 576, results from the target server node(s) can be received and a determination of whether to utilize or not utilize the results can be based on consistency of results and/or a level indicated by a memory resiliency or health indicator is more than a threshold level. Based on consistent results and memory resiliency or health indicator is more than the threshold level, data from the results can be available to be processed by a service initiator process. Based on inconsistent results and/or memory resiliency or health indicator is less than the threshold level, data from the results may not be available to be processed by a service initiator process.

Process 580 can be performed by a server node. At 582, a target server node can receive a request to perform a workload. At 584, the target server node can provide a result of a workload with a memory resiliency or health indicator. For example, the memory resiliency or health indicator can be generated by a management controller or other process and indicate a level of errors in memory of the target server node.

FIG. 6 depicts an example system. Host 600 can include processors, memory devices, device interfaces, as well as other circuitry such as described with respect to FIG. 7. Processors of host 600 can execute software such as processes (e.g., applications, microservices, virtual machine (VMs), microVMs, containers, processes, threads, or other virtualized execution environments), operating system (OS), and device drivers. An OS or device driver can configure network interface device or packet processing device 610 to utilize one or more control planes to communicate with software defined networking (SDN) controller 645 via a network to configure operation of the one or more control planes. Host 600 can be coupled to network interface device 610 via a host or device interface 644.

Network interface device 610 can include multiple compute complexes, such as an Acceleration Compute Complex (ACC) 620 and Management Compute Complex (MCC) 630, as well as packet processing circuitry 640 and network interface technologies for communication with other devices via a network. ACC 620 can be implemented as one or more of: a microprocessor, processor, accelerator, field programmable gate array (FPGA), application specific integrated circuit (ASIC) or circuitry described at least with respect to FIG. 7. Similarly, MCC 630 can be implemented as one or more of: a microprocessor, processor, accelerator, field programmable gate array (FPGA), application specific integrated circuit (ASIC) or circuitry described at least with respect to FIG. 7. In some examples, ACC 620 and MCC 630 can be implemented as separate cores in a CPU, different cores in different CPUs, different processors in a same integrated circuit, different processors in different integrated circuit.

Network interface device 610 can be implemented as one or more of: a microprocessor, processor, accelerator, field programmable gate array (FPGA), application specific integrated circuit (ASIC) or circuitry described at least with respect to FIG. 7. Packet processing pipeline circuitry 640 can process packets as directed or configured by one or more control planes executed by multiple compute complexes. In some examples, ACC 620 and MCC 630 can execute respective control planes 622 and 632.

SDN controller 645 can upgrade or reconfigure software executing on ACC 620 (e.g., control plane 622 and/or control plane 632) through contents of packets received through packet processing device 610. In some examples, ACC 620 can execute control plane operating system (OS) (e.g., Linux) and/or a control plane application 622 (e.g., user space or kernel modules) used by SDN controller 645 to configure operation of packet processing pipeline 640. Control plane application 622 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 645 can communicate with ACC 620 using a remote procedure call (RPC) such as Google remote procedure call (gRPC) or other service and ACC 620 can convert the request to target specific protocol buffer (protobuf) request to MCC 630. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 645 can provide packet processing rules for performance by ACC 620. For example, ACC 620 can program table rules (e.g., header field match and corresponding action) applied by packet processing pipeline circuitry 640 based on change in policy and changes in VMs, containers, microservices, applications, or other processes. ACC 620 can be configured to provide network policy as flow cache rules into a table to configure operation of packet processing pipeline 640. For example, the ACC-executed control plane application 622 can configure rule tables applied by packet processing pipeline circuitry 640 with rules to define a traffic destination based on packet type and content. ACC 620 can program table rules (e.g., match-action) into memory accessible to packet processing pipeline circuitry 640 based on change in policy and changes in VMs.

For example, ACC 620 can execute a virtual switch such as vSwitch or Open vSwitch (OVS), Stratum, or Vector Packet Processing (VPP) that provides communications between virtual machines executed by host 600 or with other devices connected to a network. For example, ACC 620 can configure packet processing pipeline circuitry 640 as to which VM is to receive traffic and what kind of traffic a VM can transmit. For example, packet processing pipeline circuitry 640 can execute a virtual switch such as vSwitch or Open vSwitch that provides communications between virtual machines executed by host 600 and packet processing device 610.

MCC 630 can execute a host management control plane, global resource manager, and perform hardware registers configuration. Control plane 632 executed by MCC 630 can perform provisioning and configuration of packet processing circuitry 640. For example, a VM executing on host 600 can utilize packet processing device 610 to receive or transmit packet traffic. MCC 630 can execute boot, power, management, and manageability software (SW) or firmware (FW) code to boot and initialize the packet processing device 610, manage the device power consumption, provide connectivity to a management controller (e.g., Baseboard Management Controller (BMC)), and other operations.

One or both control planes of ACC 620 and MCC 630 can define traffic routing table content and network topology applied by packet processing circuitry 640 to select a path of a packet in a network to a next hop or to a destination network-connected device. For example, a VM executing on host 600 can utilize packet processing device 610 to receive or transmit packet traffic.

ACC 620 can execute control plane drivers to communicate with MCC 630. At least to provide a configuration and provisioning interface between control planes 622 and 632, communication interface 625 can provide control-plane-to-control plane communications. Control plane 632 can perform a gatekeeper operation for configuration of shared resources. For example, via communication interface 625, ACC control plane 622 can communicate with control plane 632 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 625 can be utilized by a negotiation protocol and configuration protocol running between ACC control plane 622 and MCC control plane 632. Communication interface 625 can include a general purpose mailbox for different operations performed by packet processing circuitry 640. Examples of operations of packet processing circuitry 640 include issuance of Non-volatile Memory Express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 625 can include one or more mailboxes accessible as registers or memory addresses. For communications from control plane 622 to control plane 632, communications can be written to the one or more mailboxes by control plane drivers 624. For communications from control plane 632 to control plane 622, communications can be written to the one or more mailboxes. Communications written to mailboxes can include descriptors which include message opcode, message error, message parameters, and other information. Communications written to mailboxes can include defined format messages that convey data.

Communication interface 625 can provide communications based on writes or reads to particular memory addresses (e.g., dynamic random access memory (DRAM)), registers, other mailbox that is written-to and read-from to pass commands and data. To provide for secure communications between control planes 622 and 632, registers and memory addresses (and memory address translations) for communications can be available only to be written to or read from by control planes 622 and 632 or cloud service provider (CSP) software executing on ACC 620 and device vendor software, embedded software, or firmware executing on MCC 630. Communication interface 625 can support communications between multiple different compute complexes such as from host 600 to MCC 630, host 600 to ACC 620, MCC 630 to ACC 620, baseboard management controller (BMC) to MCC 630, BMC to ACC 620, or BMC to host 600.

Packet processing circuitry 640 can be implemented using one or more of: application specific integrated circuit (ASIC), field programmable gate array (FPGA), processors executing software, or other circuitry. Control plane 622 and/or 632 can configure packet processing pipeline circuitry 640 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 620 or MCC 630. In some examples, a P4 program can be compiled and provided to MCC 630 to configure packet processing circuitry 640. The following is a JSON configuration file that can be transmitted from ACC 620 to MCC 630 to get capabilities of packet processing circuitry 640 and/or other circuitry in packet processing device 610. More particularly, the file can be used to specify a number of transmit queues, number of receive queues, number of supported traffic classes (TC), number of available interrupt vectors, number of available virtual ports and the types of the ports, size of allocated memory, supported parser profiles, exact match table profiles, packet mirroring profiles, among others.

FIG. 7 depicts a system. In some examples, circuitry of system 700 can be configured to determine whether to utilize data based on associated memory health indicia and/or consistency of results, or to generate data and provide associated resiliency or memory health indicia to a requester, as described herein. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

Applications 734 and/or processes 736 can refer instead or additionally to a virtual machine (VM), container, microservice, processor, or other software.

In some examples, OS 732 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 732, a system administrator, and/or orchestrator can configure circuitry to determine whether to utilize data based on associated memory health indicia and/or consistency of results, or to generate data and provide associated resiliency or memory health indicia to a requester, as described herein.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. In some examples, packet processing device or network interface device 750 can refer to one or more of: a network interface controller (NIC), a remote direct memory access (RDMA)-enabled NIC, SmartNIC, SuperNIC with an accelerator, router, switch, forwarding element, infrastructure processing unit (IPU), edge processing unit (EPU), or data processing unit (DPU). An EPU can include a network interface device that utilizes processors and accelerators (e.g., digital signal processors (DSPs), signal processors, or wireless specific accelerators for Virtualized radio access networks (vRANs), cryptographic operations, compression/decompression, and so forth). An example IPU or DPU is described with respect to FIG. 6.

In one example, system 700 includes one or more input/output (I/O) interface(s) 760. I/O interface 760 can include one or more interface components through which a user interacts with system 700. Peripheral interface 770 can include any hardware interface not specifically mentioned above. Peripherals refer generally to devices that connect dependently to system 700.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 700 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 700 can be implemented using interconnected compute platforms of processors, memories, storages, network interfaces, and other components. High speed interconnects can be used such as PCle, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes a method comprising: sending a service request to multiple microservices executing on multiple servers, by transmission of one or more packets through a network, wherein the multiple servers comprise one or more of: a processor, a network interface device, an accelerator, or a memory device; receiving a plurality of responses, with associated reliability metrics, to the service request from the multiple microservices executing on the multiple servers, wherein the plurality of responses are received in one or more packets; and determining which response from the plurality of responses to utilize based, at least in part, on the associated reliability metrics.

Example 2 includes one or more examples, wherein at least one of the associated reliability metrics comprises an indicator of memory health and computational accuracy.

Example 3 includes one or more examples, and includes a management controller generating at least one of the associated reliability metrics.

Example 4 includes one or more examples, and includes generating an Application Programming Interface (API) response that includes at least one of the plurality of responses and at least one of the associated reliability metrics.

Example 5 includes one or more examples, and includes providing a subsequent service request to a different server based on a reliability metric of the associated reliability metrics indicating a potential error in an associated result.

Example 6 includes one or more examples, and includes initiating executions of the service request on the multiple servers based on an indicator of mission criticality; aggregating service results from the multiple servers, wherein at least one of the aggregated service results is associated with at least one of the associated reliability metrics; selecting a service result from the aggregated service results based on the at least one of the associated reliability metrics and a consistency check among the service results; and updating a database with the selected service result.

Example 7 includes one or more examples, and includes an apparatus that includes: a memory comprising instructions stored thereon and at least one processor, that based on execution of the instructions, is to: permit processing, by a first microservice, to execute on a first server, of first data received from a second server based on a memory error indicator of the second server that performs a second microservice that generates the first data and do not permit processing, by the first microservice of second data received from a third server based on a memory error indicator of the third server that performs a third microservice that generates the second data.

Example 8 includes one or more examples, wherein the memory comprises instructions stored thereon, that if executed by the at least one processor, causes the at least one processor to: cause performance of a workload by the second microservice and the third microservice on the respective second server and third server and based on receipt of the first data and the second data, permit processing of the first data based on the first data matching the second data, to reduce arithmetic computation errors or transient errors.

Example 9 includes one or more examples, wherein the memory comprises instructions stored thereon, that if executed by the at least one processor, causes the at least one processor to: transmit a first request, to perform a first workload to generate the first data, to the second server based on a first priority level of the first request and transmit a second request, to perform a second workload to generate the first data, to multiple servers based on a second priority level of the second request.

Example 10 includes one or more examples, wherein the memory comprises instructions stored thereon, that if executed by the at least one processor, causes the at least one processor to: based on receipt of data from the multiple servers, select the first data from the received data based on memory error indicator levels associated with the received data.

Example 11 includes one or more examples, wherein the memory comprises instructions stored thereon, that if executed by the at least one processor, causes the at least one processor to: select a first received data of the received data based on a memory error indicator level associated with the first received data.

Example 12 includes one or more examples, wherein the memory comprises instructions stored thereon, that if executed by the at least one processor, causes the at least one processor to: permit servers to receive a workload based on the servers being associated with a first memory error indicator level and exclude servers from receipt of the workload based on the servers being associated with a second memory error indicator level.

Example 13 includes one or more examples, wherein the memory comprises instructions stored thereon, that if executed by the at least one processor, causes the at least one processor to: select a server to perform a workload based on use of a neural network (NN) trained based on prior memory error indicator levels.

Example 14 includes one or more examples, wherein the memory comprises instructions stored thereon, that if executed by the at least one processor, causes the at least one processor to: prior to transmitting workload requests to the first server and the second server, determine memory error indicator levels of multiple servers and select the first server and the second server based on the memory error indicator levels.

Example 15 includes one or more examples, wherein the memory error indicator comprises one or more of: faulty double memory device, number of corrected errors by Error Correction Code (ECC) operations, number of uncorrected errors by ECC operations, number of computation errors, number of row faults, number of column faults, or number of bank faults.

Example 16 includes one or more examples, and includes at least one non-transitory computer-readable medium comprising instructions stored thereon, that if executed by one or more processors, cause the one or more processors to: perform a process that is to: issue a service request to a second process; process data generated by the service request based on a response that includes a memory resiliency indicator; issue a second service request with a priority level; based on the priority level, initiating executions of the second service request on multiple nodes based on the priority level; and process second data, from among data returned by the multiple nodes based on consistency among the returned data.

Example 17 includes one or more examples, wherein the memory resiliency indicator comprises one or more of: faulty double memory device, number of corrected errors by Error Correction Code (ECC) operations, number of uncorrected errors by ECC operations, number of computation errors, number of row faults, number of column faults, or number of bank faults.

Example 18 includes one or more examples, comprising instructions stored thereon, that if executed by one or more processors, cause the one or more processors to: do not permit processing of the data generated by the service request based on a level of the memory resiliency indicator.

Example 19 includes one or more examples, comprising instructions stored thereon, that if executed by one or more processors, cause the one or more processors to: issue the service request to a second node based on the level of the memory resiliency indicator.

Example 20 includes one or more examples, comprising instructions stored thereon, that if executed by one or more processors, cause the one or more processors to: issue the second service request to at least one other node based on inconsistency among the returned data and process third data, from among data returned by the multiple nodes and the at least one other node based on consistency among the returned data.

1. A method comprising:
sending a service request to multiple microservices executing on multiple servers, by transmission of one or more packets through a network, wherein the multiple servers comprise one or more of: a processor, a network interface device, an accelerator, or a memory device;
receiving a plurality of responses, with associated reliability metrics, to the service request from the multiple microservices executing on the multiple servers, wherein the plurality of responses are received in one or more packets; and
determining which response from the plurality of responses to utilize based, at least in part, on the associated reliability metrics.

2. The method of claim 1, wherein at least one of the associated reliability metrics comprises an indicator of memory health and computational accuracy.

3. The method of claim 1, comprising:
a management controller generating at least one of the associated reliability metrics.

4. The method of claim 1, comprising:
generating an Application Programming Interface (API) response that includes at least one of the plurality of responses and at least one of the associated reliability metrics.

5. The method of claim 1, comprising:
providing a subsequent service request to a different server based on a reliability metric of the associated reliability metrics indicating a potential error in an associated result.

6. The method of claim 1, comprising:
initiating executions of the service request on the multiple servers based on an indicator of mission criticality;
aggregating service results from the multiple servers, wherein at least one of the aggregated service results is associated with at least one of the associated reliability metrics;
selecting a service result from the aggregated service results based on the at least one of the associated reliability metrics and a consistency check among the service results; and
updating a database with the selected service result.

7. An apparatus comprising:
a memory comprising instructions stored thereon and
at least one processor, that based on execution of the instructions, is to:
permit processing, by a first microservice, to execute on a first server, of first data received from a second server based on a memory error indicator of the second server that performs a second microservice that generates the first data and
do not permit processing, by the first microservice of second data received from a third server based on a memory error indicator of the third server that performs a third microservice that generates the second data.

8. The apparatus of claim 7, wherein the memory comprises instructions stored thereon, that if executed by the at least one processor, causes the at least one processor to:
cause performance of a workload by the second microservice and the third microservice on the respective second server and third server and
based on receipt of the first data and the second data, permit processing of the first data based on the first data matching the second data, to reduce arithmetic computation errors or transient errors.

9. The apparatus of claim 7, wherein the memory comprises instructions stored thereon, that if executed by the at least one processor, causes the at least one processor to:
transmit a first request, to perform a first workload to generate the first data, to the second server based on a first priority level of the first request and
transmit a second request, to perform a second workload to generate the first data, to multiple servers based on a second priority level of the second request.

10. The apparatus of claim 9, wherein the memory comprises instructions stored thereon, that if executed by the at least one processor, causes the at least one processor to:
based on receipt of data from the multiple servers, select the first data from the received data based on memory error indicator levels associated with the received data.

11. The apparatus of claim 9, wherein the memory comprises instructions stored thereon, that if executed by the at least one processor, causes the at least one processor to:
select a first received data of the received data based on a memory error indicator level associated with the first received data.

12. The apparatus of claim 7, wherein the memory comprises instructions stored thereon, that if executed by the at least one processor, causes the at least one processor to:
permit servers to receive a workload based on the servers being associated with a first memory error indicator level and
exclude servers from receipt of the workload based on the servers being associated with a second memory error indicator level.

13. The apparatus of claim 7, wherein the memory comprises instructions stored thereon, that if executed by the at least one processor, causes the at least one processor to:
select a server to perform a workload based on use of a neural network (NN) trained based on prior memory error indicator levels.

14. The apparatus of claim 7, wherein the memory comprises instructions stored thereon, that if executed by the at least one processor, causes the at least one processor to:
prior to transmitting workload requests to the first server and the second server, determine memory error indicator levels of multiple servers and select the first server and the second server based on the memory error indicator levels.

15. The apparatus of claim 7, wherein the memory error indicator comprises one or more of: faulty double memory device, number of corrected errors by Error Correction Code (ECC) operations, number of uncorrected errors by ECC operations, number of computation errors, number of row faults, number of column faults, or number of bank faults.

16. At least one non-transitory computer-readable medium comprising instructions stored thereon, that if executed by one or more processors, cause the one or more processors to:
perform a process that is to:
issue a service request to a second process;
process data generated by the service request based on a response that includes a memory resiliency indicator;
issue a second service request with a priority level;
based on the priority level, initiating executions of the second service request on multiple nodes based on the priority level; and
process second data, from among data returned by the multiple nodes based on consistency among the returned data.

17. The non-transitory computer-readable medium of claim 16, wherein the memory resiliency indicator comprises one or more of: faulty double memory device, number of corrected errors by Error Correction Code (ECC) operations, number of uncorrected errors by ECC operations, number of computation errors, number of row faults, number of column faults, or number of bank faults.

18. The non-transitory computer-readable medium of claim 16, comprising instructions stored thereon, that if executed by one or more processors, cause the one or more processors to:
do not permit processing of the data generated by the service request based on a level of the memory resiliency indicator.

19. The non-transitory computer-readable medium of claim 18, comprising instructions stored thereon, that if executed by one or more processors, cause the one or more processors to:
issue the service request to a second node based on the level of the memory resiliency indicator.

20. The non-transitory computer-readable medium of claim 16, comprising instructions stored thereon, that if executed by one or more processors, cause the one or more processors to:
issue the second service request to at least one other node based on inconsistency among the returned data and
process third data, from among data returned by the multiple nodes and the at least one other node based on consistency among the returned data.
